(19) United States
(12) Patent Application Publication
(10) Pub. No.: US 2016/0042574 A1
(43) Pub. Date: Feb. 11, 2016

(54) PRINTING DEVICE AND PRINTING SYSTEM

(71) Applicant: SEIKO EPSON CORPORATION, Tokyo (JP)

(72) Inventor: Shinichi Yoshie, Tatsuno-machi (JP)

(73) Assignee: SEIKO EPSON CORPORATION, Tokyo (JP)

(21) Appl. No.: 14/436,736

(22) PCT Filed: Dec. 2, 2013
(86) PCT No.: PCT/JP2013/007049

§ 371 Date: Aug. 24, 2015

(30) Foreign Application Priority Data
Dec. 13, 2012 (JP) 2012-272045

(51) Int. Cl. G07B 5/06; H04N 1/00; G06F 3/12; H04N 1/32

(52) U.S. Cl. CPC G07B 5/06; H04N 1/32325; H04N 1/00244; G06F 3/1222; G06F 3/1238; H04N 2201/323

(57) ABSTRACT

To prevent forgery of printouts by a simple configuration that can be easily introduced to an existing system, a printer 3 that prints a receipt based on print data sent from a POS terminal 2 has: a code generating unit 33 that generates a unique code unique to each receipt based on the print data; a print control unit 31 and print unit 45 that print a receipt based on the print data, and print the unique code on the receipt; and a code transmission unit 34 that outputs the unique code to a receipt history server 6.

Priority is claimed under 35 U.S.C. §119 to Japanese Application No. 2012-272045 filed on Dec. 13, 2012 and under 35 U.S.C. §365 to PCT/JP2013/007049 filed on Dec. 2, 2013.

### TECHNICAL FIELD

The present invention relates to a printing device and to a printing system.

### BACKGROUND

Devices that print information for preventing tampering on printouts are known from the literature (see, for example, PTL 1). When printing a receipt with a receipt printer connected to a POS terminal, the device in PTL 1 uses invisible ink to print encrypted information in which some of the printed transaction information is encrypted. The encrypted information is read and decrypted by a special scanner, and the authenticity of the receipt is determined based on whether or not the content of the decrypted transaction information is appropriate.

### PATENT LITERATURE

[PTL 1] JP-A-2011-20439

### SUMMARY OF INVENTION

The configuration described in PTL 1 uses encrypted information to prevent tampering, and requires decryption to determine authenticity. Because the processing load is therefore great, a high performance device is therefore required. Managing key information is also necessary because encryption and decryption are done by different devices, and after-market introduction to an existing system having POS terminals, for example, is not easy. Providing the ability to prevent tampering with printed materials using a configuration that is simpler and can be easily introduced is therefore desirable.

The present invention is directed to the foregoing problem, and an objective of the invention is to prevent forgery of printed materials by means of a simple configuration that can be easily introduced to even existing systems.

### Solution to Problem

To achieve the foregoing objective, the invention is a printing device that prints a form based on print data sent from a host device, and is characterized by: an information generating means that generates form information unique to each form based on the print data; a print means that prints the form based on the print data, and prints the form information on the form; and an output means that outputs the form information to an external device.

Because the invention generates form information unique to each form based on print data sent from a host device, and outputs the form information to an external device, whether or not a form is authentic can be evaluated based on the form information on the external device without affecting the configuration of the host device. As a result, by connecting the printing device of the invention to an existing host device, whether or not a form the printing device printed is authentic can be easily evaluated, and a suppression effect on forgery of printouts can be expected.

In the foregoing configuration, the output means has a function of sending the print data sent from the host device to the external device, and generates and sends the form information at each break in the print data for one form.

Because print data and form information are sent to the external device in this aspect of the invention, whether or not a form is authentic can be determined on the external device based on the form information, and authenticity can be determined based on content printed on the form.

In the foregoing configuration, the printing device may have a setting storage means that stores a setting related to the operation of at least one of printing the form information on the form, or sending the print data; and a setting changing means that changes a setting stored in the setting storage means based on a command sent from the host device; the print means printing the form information on the form according to a setting the setting storage means stores; and the output means outputting the form information to an external device according to a setting the setting storage means stores.

In this aspect of the invention, an operation of printing form information on a form, and an operation of transmitting print data, can be executed according to a previous setting. Whether or not to print form information on a form, and whether or not to transmit the print data, can also be easily set by sending a command from the host device.

In the above configuration, the output means may have a function of outputting a report of printing completion to the external device each time printing one form by the print means is completed.

Because completion of printing is reported to the external device in this aspect of the invention, form information related to a form for which printing failed or that was not printed can be appropriately processed by the external device. For example, by using only the form information of forms for which printing completed for evaluation of authenticity on the external device, forgery of forms that did not print can be prevented. As a result, the accuracy of determining authenticity can be further improved.

In the above configuration, the printing device may also have an automatic cutter that cuts the form printed by the print means; the output means determining printing completed and outputting a report of printing completion when an error of the automatic cutter is not detected after executing a command sent from the host device instructing operation of the automatic cutter.

Because whether or not printing of a form completed can be appropriately determined based on operation of the automatic cutter, this aspect of the invention can output an accurate report related to completion of printing to the external device. As a result, whether or not a form is authentic can be more accurately determined on the external device.

In the above configuration, the output means may determine printing completed when an error is not detected in the time until the operating sequence of the automatic cutter ends after a command sent from the host device instructing operation of the automatic cutter is executed.

This aspect of the invention can output an accurate report of completion of printing to the external device because whether or not printing a form completed can be appropriately determined based on operation of the automatic cutter. As a result, whether or not a form is authentic can be more accurately determined on the external device.

To achieve the foregoing objective, another aspect of the invention includes a printing device described above; and a server device having a database that stores form information output from the printing device, a reading means that reads form information printed on a form being evaluated, and an evaluation means that evaluates the read result by comparing the read result of the reading means with the form information stored in the database.

Because the invention generates form information unique to each form based on print data sent from a host device, and a server device stores the form information, the server device can determine whether or not a form is authentic based on the form information without affecting the configuration of the host device. As a result, by connecting the printing system of the invention to an existing host device, whether or not a form the printing device printed is authentic can be easily evaluated, and a suppression effect on forgery of printouts can be expected.

In this configuration, the server device may include a form information acquisition means that acquires the form information output from the printing device, and a database control means that stores the form information acquired by the form information acquisition means in the database when a report of printing completion is output from the printing device.

Because the server device stores form information related to forms that printed completely in a database, form information related to forms that did not print completely is not stored. As a result, because form information of forms that printed completely is used for evaluation, forgery of forms that did not print completely can be prevented. As a result, the accuracy of determining authenticity can be further improved.

### Advantageous Effects of Invention

The invention enables easily determining whether or not a printed form is authentic, and a suppression effect on forgery of printouts can be expected, without changing the configuration of the existing host device.

### BRIEF DESCRIPTION OF DRAWINGS

FIG. 1 is a function block diagram of a printing system according to an embodiment of the invention.

FIG. 2 schematically illustrates an example of the configuration of information stored in a receipt database.

FIG. 3 shows an example of a receipt output by a printer.

FIG. 4 is a flow chart showing the operation of the printing system.

FIG. 5 is a flowchart showing the operation of a receipt history server.

### DETAILED DESCRIPTION

### Embodiment 1

A preferred embodiment of the invention is described below with reference to the accompanying figures.

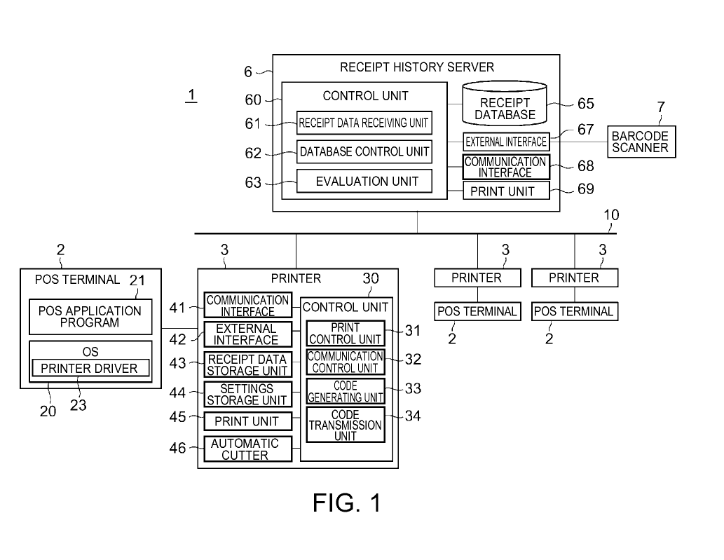

FIG. 1 illustrates the configuration of a printing system 1 according to an embodiment of the invention. The printing system 1 embodies a so-called POS system that is used in retail stores and other businesses. The printing system 1 includes, for example, a POS terminal 2 installed at each checkout counter in a store, a printer 3 (printing device) that is connected to the POS terminal 2 and prints receipts (forms), and a receipt history server 6 (external device, server device). A communication network 10 through which the POS terminal 2 and receipt history server 6 are connected and can communicate data with each other is a communication line, and in this example is a LAN deployed in the store. The communication network 10 may be a wide-area communication network such as the Internet, in which event printers 3 and receipt history servers 6 installed in plural stores, including remote locations, can also be connected.

The printing system 1 in this embodiment of the invention has plural POS terminals 2 and printers 3, with one POS terminal 2 combined with one printer 3 installed at one checkout counter. Because the plural POS terminals 2 are similarly configured, and the plural printers 3 are similarly configured, FIG. 1 shows the functional configuration of one POS terminal 2 and printer 3.

The printing system 1 is a configuration connecting a printer 3 and receipt history server 6 embodying a printing system according to the invention to a POS terminal 2. The printing system 1 may be a completely new construction including the POS terminal 2, but can also be constructed by connecting the printer 3 to an existing POS terminal 2, installing a communication network 10, and connecting the receipt history server 6. In this event, the old printer (not shown in the figure) that was connected to the POS terminal 2 is removed and replaced with the printer 3. If the printer 3 can operate based on the commands and data that the POS terminal 2 output to the old printer, the printing system 1 can be constructed without changing the software or the hardware of the POS terminal 2. In this event, the printer 3 and the receipt history server 6 can function as a printing system 1 according to the invention by the POS terminal 2 simply executing the payment process related to product sales, and the process that outputs print data for printing a receipt including the result of the payment process.

The printer 3 in this printing system 1 prints and outputs receipts based on print data the POS terminal 2 outputs (sends). The printer 3 also generates a unique code for each single receipt, prints the generated unique code on the receipt, and outputs (sends) the unique code through the communication network 10 to the receipt history server 6. The unique code the printer 3 generates is information for distinguishing (identifying) a receipt printed by a printer 3 in the printing system 1 from other printouts. For example, if a customer presents a receipt as a record of shopping in the store where the printing system 1 is deployed, whether or not that receipt was produced by that store can be determined. The unique code can also be used to determine if the presented receipt is a forged receipt or an authentic receipt. In other words, the printing system 1 has the ability to differentiate receipts produced by the printing system 1 from other printouts, and one method of using this ability is to determine whether or not a receipt is authentic or not. An example of using the printing system 1 to determine whether or not a receipt is authentic is described below.

Below, an “authentic receipt” means a receipt that was printed and output by a printer 3 in the printing system 1. “Evaluation of authenticity” means a process of distinguishing a receipt printed by a printer 3 in the printing system 1 from other printouts. A “forged receipt” is a term indicating a printout that was not printed by a printer 3 of the printing system 1, and there is no intent to limit it to a receipt that was produced or forged with ill intent.

The unique code the printer 3 generates is information unique to each receipt. The printer 3 converts the generated unique code to a barcode, and prints the barcode on the receipt. The receipt history server 6 receives and stores the unique code sent from the printer 3 in a receipt database (DB) 65 described below. Because each of the plural printers 3 in the printing system 1 executes this operation, unique codes related to the receipts produced by the plural printers 3 are sent to the receipt history server 6 and accumulated in the receipt database 65.

The receipt history server 6 executes the operation of determining the authenticity of a receipt. The receipt history server 6 has a barcode scanner 7, and gets the unique code printed on the receipt by reading the barcode printed on the target receipt being evaluated. The receipt history server 6 determines if a unique code matching the read unique code is stored in the receipt database 65. The receipt history server 6 also has a print unit 69 that prints text and/or an image on roll paper, and prints and outputs the result of the decision. For example, the receipt history server 6 may print the symbol “O” if it determines the receipt is a receipt printed by a printer 3 of the printing system 1, and print the symbol “−” if it determines the receipt was not printed by a printer 3 of the printing system 1.

The POS terminal 2 includes devices not shown, such as a barcode reader for registering products that are sold, a key input unit, a customer display for display amount information to the customer, a cash drawer holding money, and a card reader for reading credit cards or other magnetic cards. The main functions of the POS terminal 2 include, for example, tabulating the cost of products purchased by a customer at the time of sale at a checkout counter in a store, displaying the total amount, calculating change due for payment received, processing payments by credit card, and outputting transaction information for printing a receipt showing the transaction content after completing payment by cash or credit card. The transaction information includes, for example, store information such as the name of the store that sold the product, product information such as the names of sold products, product category, and product price, and financial information such as the total transaction amount, the amount received, and the change due, and is output as print data from the POS terminal 2 to the printer 3. Based on the print data input from the POS terminal 2, the printer 3 prints on internally stored roll paper (not shown in the figure) and produces a receipt.

The POS terminal 2 includes a CPU, ROM, RAM, and storage device such as flash memory or a hard disk drive not shown, and the CPU controls parts of the POS terminal 2 by running an OS (operating system) 20. The POS terminal 2 also runs a POS application program 21 by the CPU on the OS 20, and renders the functions of a POS terminal as described above.

A printer driver 23 that is a part of the OS 20 is installed on the POS terminal 2. The printer driver 23 is a printer driver program for printing by the printer 3. The printer driver 23 outputs print data for printing the transaction information generated by the POS application program 21 in a specific format to the printer 3.

The print data the printer driver 23 outputs includes data printed on the receipt, and commands for printing the data. More specifically, the print data includes character data and image data for printing standard information such as the logo of the store where the POS terminal 2 is installed, and the transaction information generated by the POS application program 21. The print data includes commands such as a print command instructing printing, a command specifying the print format, and an automatic cutter command instructing cutting with the automatic cutter unit described below.

The printer 3 has a control unit 30 including a CPU, ROM, and RAM not shown, and the control unit 30 controls other parts of the printer 3. The printer 3 is connected to the communication network 10, and has a communication interface 41 that exchanges data with the receipt history server 6 through the communication network 10. The printer 3 also has an external interface 42 to which the POS terminal 2 or other devices connect, and a printhead and conveyance rollers. The printer 3 also has a print unit 45 for printing text and images on roll paper (not shown in the figure), and an automatic cutter unit 46 (automatic cutter) for cutting the roll paper printed by the print unit 45.

The printer 3 also has a storage device with flash memory or a hard disk drive, and disposed in the storage area of this storage device are a receipt data storage unit 43 that stores print data, for example, input from the POS terminal 2, and a settings storage unit 44 (setting storage means) that stores settings related to the operation of the printer 3. The settings storage unit 44 is a so-called memory switch that nonvolatilely stores different settings.

The values stored in the settings storage unit 44 can be set by the POS terminal 2 sending a set command to the printer 3. More specifically, the POS terminal 2 sends a parameter denoting the type of the value to be set, and a parameter denoting the value to set, to the printer 3 in the command specifying setting a value. The control unit 30 receives the command and parameters sent from the POS terminal 2, and overwrites the value stored in the settings storage unit 44. As a result, the operation of the printer 3 based on the unique code of a receipt can be set by the POS terminal 2. This process can be achieved by providing the POS terminal 2 with a function for sending this set command to the printer 3. The POS terminal 2 normally has a function for sending various commands including print commands to the printer 3. As a result, the POS terminal 2 can be provided with the ability to send this set command by simply increasing (expanding) the types of commands that the POS terminal 2 can send. This expansion can be done easily without changing the POS application program 21 of the POS terminal 2 or the specifications of the printer driver 23. Expansion can therefore be accomplished easily without great modification of the system even when using an existing POS terminal 2.

The control unit 30 has a print control unit 31 that controls the print unit 45 based on print commands and print data input from the POS terminal 2, and prints receipts. The print control unit 31 and the print unit 45 together embody the print means of the invention.

The print control unit 31 also has a communication control unit 32 that controls the communication interface 41, and sends and receives data between the printer 3 and the receipt history server 6. The communication control unit 32 can also send and receive (input/output) signals and data to and from the POS terminal 2 through the external interface 42.

The control unit 30 also has a code generating unit 33 (information generating means) that generates unique codes based on print data input from the POS terminal 2; and a code transmission unit 34 (output means) that sends the unique codes generated by the code generating unit 33 to the receipt history server 6 through the communication interface 41.

The code generating unit 33 may generate the unique codes based not only on the print data the POS terminal 2 sends, but also using information such as the store name or store number of the store where the POS terminal 2 is installed, information related to the date and time the POS terminal 2 executed the payment process or the date and time the POS terminal 2 outputs the print data, and information including the network address previously assigned to the communication interface 41. Information may also be desirably selected from among the foregoing information and used to generate the unique codes. A method that calculates a hash value for the source data can be used as the method of generating the unique codes, but various known methods that summarize the source data can alternatively be used, and if the method can acquire a unique value for each receipt, the specific method is not particularly limited.

The code transmission unit 34 sends the unique code generated by the code generating unit 33 to the receipt history server 6. The code transmission unit 34 may also send the print data from which the code generating unit 33 generated the unique code to the receipt history server 6 together with the unique code the code generating unit 33 generated. The code transmission unit 34 may also send information identifying the printer 3 in the printing system 1 to the receipt history server 6 together with the print data and unique code.

The printer 3 may also have a buzzer or indicator for reporting the operating status to the operator, an operating panel operated by the operator, and other components not shown.

The receipt history server 6 has a control unit 60 including a CPU, ROM, and RAM not shown, and the control unit 60 controls other parts of the receipt history server 6. The receipt history server 6 also has an external interface 67 connected to a barcode scanner 7; a communication interface 68 that is connected to the communication network 10 and sends and receives data to and from the printer 3 through the communication network 10; and a print unit 69 that has a printhead and conveyance roller, and prints text and images on roll paper (not shown in the figure).

The receipt history server 6 also has an in-built storage device with flash memory or a hard disk drive, and a receipt database 65 that stores the unique codes and print data received from the printer 3 is disposed in the storage area of the storage device.

The control unit 60 includes a receipt data receiving unit 61, a database (DB) control unit 62 (database control means), and an evaluation unit 63 (evaluation means). The receipt data receiving unit 61 receives the print data and unique codes for receipts sent by the printer 3 through the communication interface 68. The database control unit 62 generates a record to be stored in the receipt database 65 based on the information the receipt data receiving unit 61 received, and stores the record in the receipt database 65. The evaluation unit 63 determines the authenticity of receipts based on the information stored in the receipt database 65.

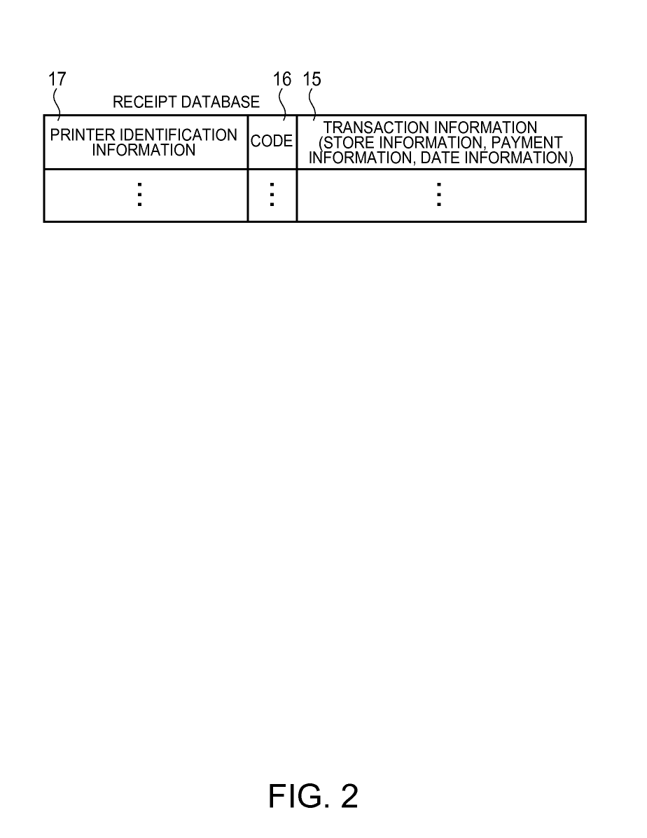

FIG. 2 shows an example of information stored in the receipt database 65.

As shown in FIG. 2, the information stored in the receipt database 65 constitutes one record linking transaction information 15 with a code 16 and printer identification information 17. The transaction information 15 is data extracted from the print data the POS terminal 2 sent to the printer 3. Included in the transaction information 15 is store information identifying the store where the POS terminal 2 is located, payment information printed on the receipt, and date and time information indicating the date and time the POS terminal 2 commanded printing the receipt, or the date and time the POS terminal 2 executed the payment process. The transaction information 15 may also include print commands the POS terminal 2 output, for example.

The code 16 is the unique code the printer 3 generated and sent to the receipt history server 6. This unique code is sent by the printer 3 with the print data.

The receipt history server 6 receives the print data and unique code the printer 3 sent by the receipt data receiving unit 61, generates the transaction information 15 from the print data by the database control unit 62, and relationally stores the transaction information 15 and code 16 in the receipt database 65. The printer identification information 17 is information identifying the printer 3 that sent the code 16 and the print data on which the transaction information 15 was based. The printer identification information 17 is information, such as an ID previously stored in the printer 3, enabling identifying one printer 3 in the group of plural printers 3 in the printing system 1. The network address (IP address or MAC address, for example) of the printer 3 on the communication network 10 can also be used as the printer identification information 17. The receipt history server 6 acquires or receives information identifying the sending printer 3 when receiving the print data and unique code by the receipt data receiving unit 61. The database control unit 62 saves the information identifying the sending printer 3 acquired by the receipt data receiving unit 61 as the printer identification information 17 in the receipt database 65.

The evaluation unit 63 controls the barcode scanner 7 (reading means) connected through the external interface 67, decodes the barcode read by the barcode scanner 7, and acquires the unique code to be evaluated. The evaluation unit 63 references the many unique codes 16 stored in the receipt database 65 for evaluation. If there is a unique code 16 matching the unique code being evaluated, the evaluation unit 63 sets the result to “match (authentic)”, and if there is not a matching unique code 16, sets the result to “no match (forgery)”. The evaluation unit 63 controls the print unit 69 to print and output a message, symbol, or graphic, for example, identifying the result.

If the result is a match, the evaluation unit 63 retrieves the transaction information 15 corresponding to the unique code 16 that matched from the receipt database 65, and also prints the content of this transaction information 15 by the print unit 69. To simplify comparison with the receipt being evaluated, the evaluation unit 63 may print the transaction information 15 with the same layout as the receipt.

The operator accessing the receipt history server 6 can then look at the evaluation result printed by the print unit 69, and determine whether or not the receipt is authentic. If the evaluation result is there is no match, it will be obvious that the printout read by the barcode scanner 7 is not a receipt printed by the printing system 1.

If the evaluation result is that there is a match, the possibility that the receipt was produced by the printing system 1 is high. In this event, when the transaction information 15 is printed with the evaluation result, the operator can visually compare the printed transaction information 15 with the payment and other information printed on the receipt read by the barcode scanner 7. If there is a mismatch in this information between amount, product name, quantity, or other information, it will be obvious that the receipt is not a receipt that was produced by the printing system 1 even if the unique code that was read by the barcode scanner 7 is an authentic unique code. In this case, whether or not the receipt is authentic can be determined more accurately and precisely.

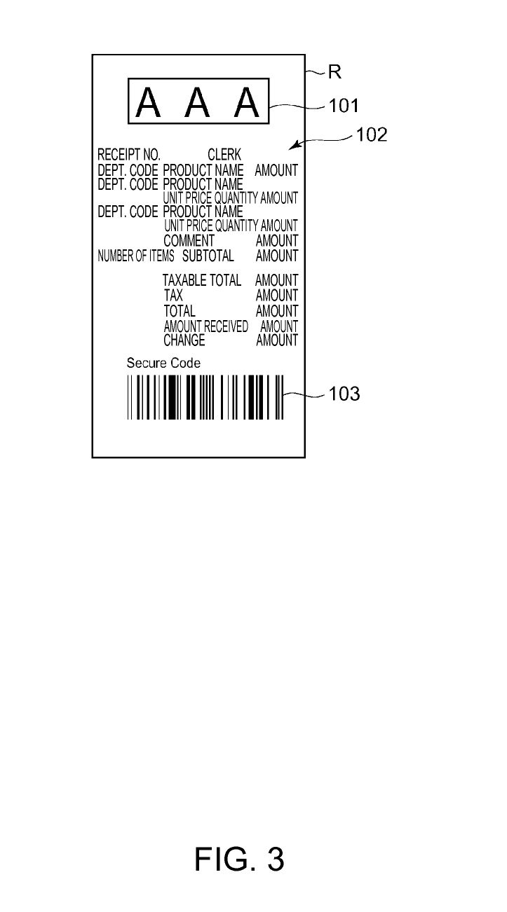

FIG. 3 shows an example of a receipt R that a printer 3 of the printing system 1 outputs.

Like a common receipt, a logo 101 of the store where the POS terminal 2 is located, and payment information 102 are printed on this receipt R.

A barcode 103 generated from the unique code produced by the printer 3 is also printed on the receipt R. Because the unique code is normally a numeric or text string, the barcode 103 may be a linear barcode of a 2D barcode such as a QR code (T). The barcode 103 is printed at the trailing end after content based on the print data the POS terminal 2 sent is printed, that is, after the logo 101 and payment information 102 are printed. The printer 3 can print the barcode 103 with no control by the POS terminal 2 related to printing the printer 3. As a result, the POS terminal 2 only needs to have the ability to print a normal receipt, and a general purpose or existing POS terminal 2 can be used.

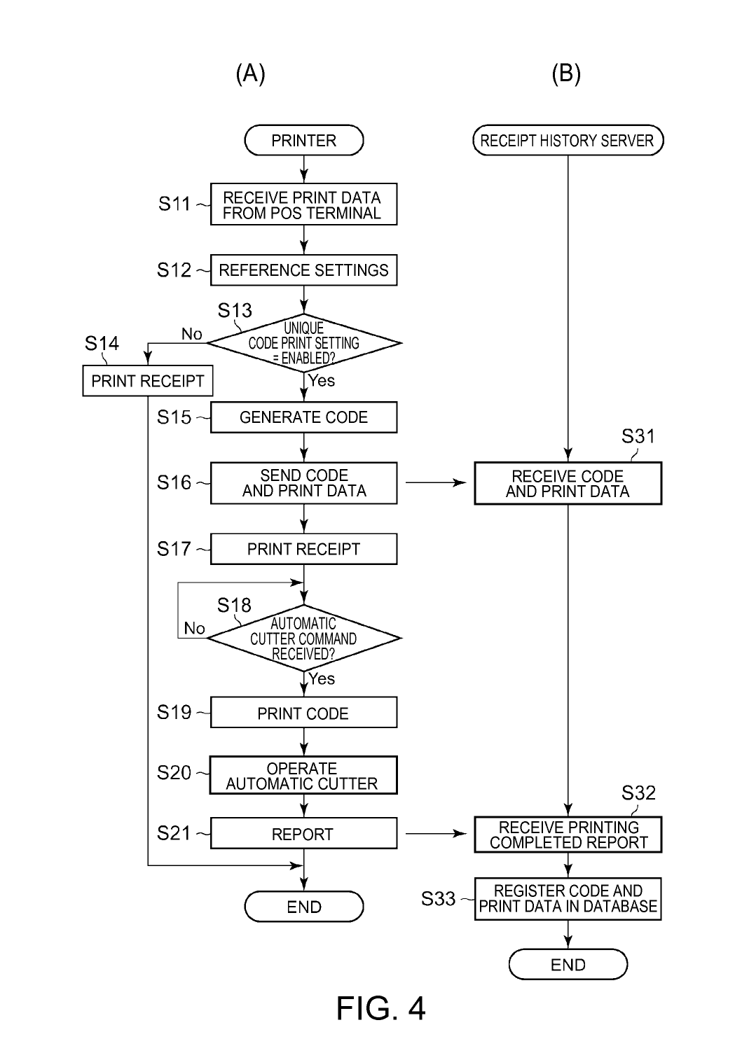

FIG. 4 is a flow chart showing the operation of the printing system 1, particularly the operation that prints a receipt. In FIG. 4, (A) shows the operation of the printer 3, and (B) shows the operation of the receipt history server 6.

First, the POS terminal 2 executes the payment process related to sale of a product, and sends print data including a print command and data to the printer 3. The print control unit 31 receives and temporarily stores the print data the POS terminal 2 sends in the receipt data storage unit 43 (step S11). The code generating unit 33 references settings in the settings storage unit 44 (step S12), and determines if the value of the unique code print setting is Enabled (step S13). The value of the unique code print setting is a value setting whether to generate a unique code by the code generating unit 33 and print a barcode 103 (FIG. 3), or to print a regular receipt. In this embodiment of the invention, the value of the unique code print setting also functions as a value setting whether or not to send the print data to the receipt history server 6.

If the value of the unique code print setting is not Enabled (step S13 returns NO), the code generating unit 33 does not generate a unique code, the print control unit 31 prints a receipt based on the print data (step S14), and this process ends.

However, if the value of the unique code print setting is Enabled (step S13 returns YES), the control unit 30 executes an operation printing a unique code on the receipt, and an operation sending the print data to the receipt history server. More specifically, the code generating unit 33 generates a unique code based on the print data, for example, the print control unit 31 received, and temporarily stores the unique code in the receipt data storage unit 43 (step S15).

The code transmission unit 34 acquires the unique code and print data stored in the receipt data storage unit 43, and causes the communication control unit 32 and communication interface 41 to operate and send it to the receipt history server 6 (step S17).

On the receipt history server 6, the receipt data receiving unit 61 receives and temporarily stores the print data and unique code sent from the printer 3 in a temporary storage area not shown (step S31).

The print control unit 31 then controls the print unit 45 and prints the logo 101 (FIG. 3) and payment information 102 (FIG. 3) based on the print data received in step S11 (step S17). Next, the print control unit 31 waits until an automatic cutter command is received from the POS terminal 2 (step S18). When the automatic cutter command is received (step S18 returns YES), the print control unit 31 prints the unique code stored in the receipt data storage unit 43 in a barcode 103 at the trailing end of the payment information 102 (step S19). The process of converting the unique code to a barcode may be executed by the code generating unit 33 or executed by the print control unit 31.

After printing the barcode 103, the print control unit 31 operates the automatic cutter 46 according the automatic cutter command to cut the printed roll paper (step S20). After the print control unit 31 operates the automatic cutter 46, the code transmission unit 34 waits the time required for operation of the automatic cutter 46 to finish, and if an automatic cutter 46 error does not occur during this time, reports completion of printing to the receipt history server 6 (step S21).

The code transmission unit 34 has information related to the time required for the operating sequence of the automatic cutter 46, or the time until the operating sequence of the automatic cutter 46 reliably ends. The operating sequence of the automatic cutter 46 is, more specifically, the operation from the start of cutter operation driving the movable knife of the automatic cutter 46 until the movable knife moves to the position completing the cut or to the end position of cutter movement. The movable knife of the automatic cutter 46 returning from completion of the cut to the position before cutting started (the initial position) may also be included in this operating sequence of the automatic cutter 46.

In the receipt history server 6, the receipt data receiving unit 61 receives the printing completed report sent from the printer 3 (step S32), and the database control unit 62 generates one record from the temporarily stored print data and unique code and registers the record in the receipt database 65 (step S33).

The operation shown in FIG. 4 describes an example in which the printer 3 receives all print data for a receipt from the POS terminal 2, and then starts the printing operation. Alternatively, the POS terminal 2 could send the print data sequentially from the beginning, and the printer 3 could sequentially receive the print data and execute the printing operation based on the portion of print data that was received. In this event, the printer 3 operates according to the commands and data in the print data that has already been received even if only part of the print data has been received. In this event, the control unit 30 of the printer 3 executes the operation from step S12 after receiving part of the print data in step S11. While executing the operation from step S12, the control unit 30 waits for print data sent sequentially from the POS terminal 2, and receives the print data each time it is sent.

In addition, the operation of FIG. 4 describes an example in which the code transmission unit 34 sends the unique code and print data in step S16 each time the code generating unit 33 generates a unique code. Alternatively, the codes generated by the code generating unit 33 and the print data may be temporarily stored in the receipt data storage unit 43, and transmitted in a batch, for example. More specifically, the code transmission unit 34 may transmit the print data and unique code for one receipt to the receipt history server 6 after printing the one receipt ends. In this event, there is no need to report completion of printing in step S21 because printing is already completed.

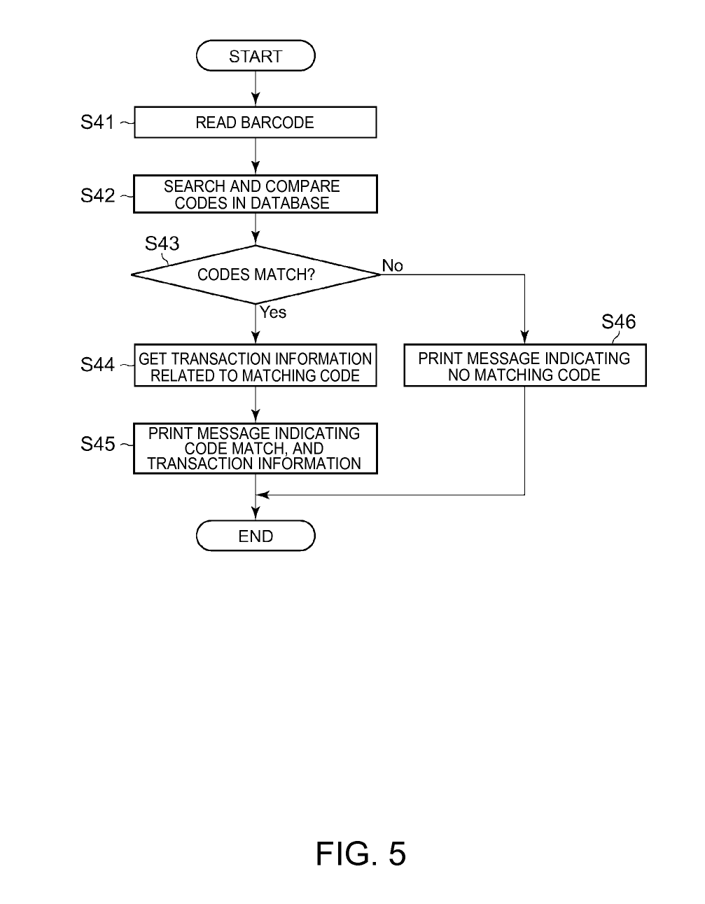

FIG. 5 is a flow chart describing the operation of the receipt history server 6, and more specifically the operation evaluating the authenticity of a receipt.

First, the barcode printed on a receipt to be evaluated is read by the barcode scanner 7 by an operation of the operator. The evaluation unit 63 drives the barcode scanner 7 to read through the external interface 67, acquires and decodes the read signal of the barcode scanner 7, and converts the read signal to a unique code (step S41).

The evaluation unit 63 compares and collates the unique code acquired from the read signal against the unique codes stored in the receipt database 65 (step S42). More specifically, the evaluation unit 63 searches the receipt database 65 for a unique code that matches the unique code acquired from the read signal. The evaluation unit 63 determines if there is a matching unique code, that is, if there is a unique code that is the same as the unique code acquired from the read signal (step S43).

If there is a matching unique code (step S43 returns YES), the evaluation unit 63 acquires the transaction information stored in the receipt database 65 in the same record as the matching unique code (step S44). The evaluation unit 63 then prints a message or image, for example, indicating the evaluation result, and the transaction information acquired from the receipt database 65 (step S45).

If there is not a unique code that matches in the receipt database 65 (step S43 returns NO), the evaluation unit 63 prints a message or image, for example, indicating the evaluation result (step S46), and ends this process.

As described above, the printing system 1 according to this embodiment of the invention has a printer 3 that prints receipts based on print data sent from a POS terminal 2. The code generating unit 33 of the printer 3 generates a unique code that is unique to each receipt based on the print data. The print control unit 31 and print unit 45 print a receipt based on the print data. The code transmission unit 34 outputs the unique code to a receipt history server 6. Without affecting the configuration of the POS terminal 2, the printer 3 can determine the authenticity of a receipt based on the unique code on the receipt history server 6. As a result, by connecting the printer 3 of the invention to an existing POS terminal 2, whether or not a receipt the printer 3 prints is authentic can be easily determined, and a suppression effect on forgery of printouts can be expected.

The printing system 1 also stores the unique codes output from the printer 3 in a receipt database 65. The unique code printed on a receipt being evaluated is read by a barcode scanner 7, and the evaluation unit 63 evaluates the read result by comparing the read result of the barcode scanner 7 with the unique codes stored in the database. The receipt history server 6 can thus determine whether or not a receipt is authentic based on the unique codes without affecting the configuration of the POS terminal 2. As a result, by connecting the printing system 1 to an existing POS terminal 2, whether or not a receipt the printer 3 prints is authentic can be easily determined, and a suppression effect on forgery of printouts can be expected.

The code transmission unit 34 has a function of transmitting print data sent from the POS terminal 2 to the receipt history server 6, and at each break in print data for one receipt, generates a unique code by the code generating unit 33 and transmits. As a result, without affecting the configuration of the POS terminal 2, whether or not a receipt is authentic can be determined on the receipt history server 6 based on the unique code, and authenticity can be determined based on content printed on the receipt. For example, when the POS terminal 2 transmits print data for plural receipts in a batch or transmits sequentially, it sends a print data break command indicating a break between data for each receipt. In this event, when the code generating unit 33 detects a print data break command in the print data sent from the POS terminal 2, it identifies a break in the print data for one receipt based on this print data break command. The code generating unit 33 can then simply generate a unique code at the break in the print data for one receipt. The code generating unit 33 may also detect specific print data (for example, data indicating the end of the receipt, data indicating a logo, for example, inserted at the leading end or the trailing end of a receipt, or a cut command) contained in the print data the print control unit 31 received, and identify this data as a break in the print data for one receipt.

Each time printing one receipt by the printing means ends, the code transmission unit 34 outputs a printing completed report to the receipt history server 6. As a result, unique codes related to receipts for which printing failed or were not printed can be appropriately processed by the receipt history server 6. For example, by using only the unique codes for receipts that finished printed for authenticity evaluation on the receipt history server 6, forgery of receipts that were not completely printed can be prevented. As a result, the accuracy of authenticity evaluation can be further improved.

The printer 3 also has an automatic cutter 46 that cuts printed receipts. If an automatic cutter 46 error is not detected after executing an automatic cutter command sent from the POS terminal 2, the code transmission unit 34 determines that printing completed and outputs a printing completion report. As a result, whether or not printing of a receipt finished can be appropriately determined based on operation of the automatic cutter. An accurate report related to completion of printing can therefore be output to the receipt history server 6, and whether or not a receipt is authentic can be determined more accurately.

The code transmission unit 34 also determines printing completed when an error is not detected in the period until the operating sequence of the automatic cutter ends after executing a command sent from the POS terminal 2 instructing operation of the automatic cutter. Whether or not printing completed can therefore be appropriately determined, and an accurate report related to completion of printing can be output to the receipt history server 6.

### Embodiment 2

The foregoing embodiment describes one example applying the invention, and the invention is not limited thereto. For example, the foregoing embodiment describes an example in which the printer 3 sends the print data and unique code to the receipt history server 6 each time one receipt is printed, but the invention is not so limited, and may transmit print data and unique codes in a batch after printing plural receipts. In this event, there is no problem if the print data and unique codes are related to each receipt. In addition, the print data and unique codes sent to the receipt history server 6 may be stored in the receipt data storage unit 43 for a specific time. Further alternatively, each time the printer 3 transmits to the receipt history server 6, the unique code may be encrypted for transmission. Further alternatively, the code generating unit 33 may execute a process encrypting the generated unique codes. In this event, the receipt history server 6 may store the encrypted unique codes directly to the receipt database 65, or be configured to decrypt the encrypted unique codes.

Furthermore, the foregoing embodiment describes an example having a function that sets the value of the unique code print setting stored in a settings storage unit 44 configured as a memory switch as a value setting whether or not to print the unique code and as a value setting whether or not to send the print data to the receipt history server 6. The invention is not so limited, and can obviously separately store whether or not to print the unique code and whether or not to send the print data to the receipt history server as separate settings in the settings storage unit 44. In this configuration, the values can be individually set by, for example, sending commands from the POS terminal 2 to the printer 3.

The foregoing embodiment describes an example of a printing system 1 that has a POS terminal 2 as an example of a host device, and prints receipts as an example of a form, but the invention is not so limited and can function effectively as a deterrent power to forgery by applying the invention to a printing device or a printing system that prints tickets of value printed and output as printouts, including items such as various kinds of tickets and gift certificates.

The printing method and other detail aspects of the configuration of the print unit 45 of the printer 3 can obviously be changed as desired.

### REFERENCE SIGNS LIST

1 printing system
2 POS terminal (host device)
3 printer (printing device)
6 receipt history server (external device, server device)
7 barcode scanner (reading means)
16 code (form information)
30 control unit (setting changing means)
31 print control unit
32 communication control unit
33 code generating unit (information generating means)
34 code transmission unit (output means)
43 receipt data storage unit
44 settings storage unit (settings storage means)
45 print unit
46 automatic cutter unit (automatic cutter)
60 control unit
61 receipt data receiving unit
62 database control unit (database control means)
63 evaluation unit (evaluation means)
65 receipt database (database)
69 print unit
103 barcode
R receipt

1. A printing device that prints a form based on print data sent from a host device, comprising:
an information generating means that generates form information unique to each form based on the print data;
a print means that prints the form based on the print data, and prints the form information on the form; and
an output means that outputs the form information to an external device.

2. The printing device described in claim 1, wherein:
the output means has a function of sending the print data sent from the host device to the external device, and generates and sends the form information at each break in the print data for one form.

3. The printing device described in claim 1, further comprising:
a setting storage means that stores a setting related to the operation of at least one of printing the form information on the form, or sending the print data; and
a setting changing means that changes a setting stored in the setting storage means based on a command sent from the host device;
the print means printing the form information on the form according to a setting the setting storage means stores; and
the output means outputting the form information to an external device according to a setting the setting storage means stores.

4. The printing device described in claim 1, wherein:
the output means has a function of outputting a report of printing completion to the external device each time printing one form by the print means is completed.

5. The printing device described in claim 4, further comprising:
an automatic cutter that cuts the form printed by the print means;
the output means determining printing completed and outputting a report of printing completion when an error of the automatic cutter is not detected after executing a command sent from the host device instructing operation of the automatic cutter.

6. The printing device described in claim 5, wherein:
the output means determines printing completed when an error is not detected in the time until the operating sequence of the automatic cutter ends after a command sent from the host device instructing operation of the automatic cutter is executed.

7. A printing system comprising:
a printing device described in claim 1; and
a server device having a database that stores form information output from the printing device, a reading means that reads form information printed on a form being evaluated, and an evaluation means that evaluates the read result by comparing the read result of the reading means with the form information stored in the database.

8. The printing system described in claim 7, wherein:
the server device includes a form information acquisition means that acquires the form information output from the printing device, and
a database control means that stores the form information acquired by the form information acquisition means in the database when a report of printing completion is output from the printing device.
